(19) United States
(12) Patent Application Publication
(10) Pub. No.: US 2011/0314097 A1
(43) Pub. Date: Dec. 22, 2011

(54) METHODS, SYSTEMS, AND COMPUTER PROGRAM PRODUCTS FOR IDENTIFYING A COMMUNICANT IN A COMMUNICATION

(76) Inventor: Robert Paul Morris, Raleigh, NC (US)

(21) Appl. No.: 12/819,215

(22) Filed: Jun. 20, 2010

(51) Int. Cl. G06F 15/16

(52) U.S. Cl. 709/204

(57) ABSTRACT

Methods and systems are described for identifying a communicant in a communication. For a communication between a contactor node, representing a contactor communicant, and a contactee node, representing a contactee communicant, an identifier of one of the contactor communicant and the contactee communicant is received. Based on the received identifier, an alias is located for the contactor communicant when the received identifier identifies the contactee communicant and for the contactee communicant when the received identifier identifies the contactor communicant. Presentation information is sent to present the alias in a representation of the communication presented via an output device.

### RELATED APPLICATIONS

This application is related to the following commonly owned U.S. patent application, the entire disclosure being incorporated by reference herein: application Ser. No. ______, (Docket No 0141) filed on 2010 Jun. ______, entitled “Methods, Systems, and Program Products for Identifying a Contactee in a Communication”.

### BACKGROUND

Aliases and communications addresses for users exchanging data in various forms of network based communications have been used for identifying the users, also referred to herein as communicants, and for delivering the communications via networks. While in use for decades, communicant identifiers, in general, and aliases, in particular, have not been recognized as a tool and/or a data useful in managing, organizing, addressing, and/or adding additional information to a network-based communication.

Accordingly, there exists a need for methods, systems, and computer program products for identifying a communicant in a communication.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for identifying a communicant in a communication. In one aspect, the method includes receiving a communicant identifier identifying one of a contactor communicant and a contactee communicant in a communication, via a network, between a contactor node representing the contactor communicant and a contactee node representing the contactee communicant. The method further includes locating, based on the communicant identifier, a communicant alias for identifying the contactor communicant when the communicant identifier identifies the contactee communicant and identifying the contactee communicant when the communicant identifier identifies the contactor communicant. The method still further includes sending presentation information for presenting the communicant alias in a representation of the communication presented via an output device.

Further, a system for identifying a communicant in a communication is described. The system includes an execution environment including an instruction processing unit configured to process an instruction included in at least one of a communicant handler component, a lookup component, and a representation component. The system includes the communicant handler component configured for receiving a communicant identifier identifying one of a contactor communicant and a contactee communicant in a communication, via a network, between a contactor node representing the contactor communicant and a contactee node representing the contactee communicant. The system further includes the lookup component configured for locating, based on the communicant identifier, a communicant alias for identifying the contactor communicant when the communicant identifier identifies the contactee communicant and identifying the contactee communicant when the communicant identifier identifies the contactor communicant. The system still further includes the representation component configured for sending presentation information for presenting the communicant alias in a representation of the communication presented via an output device.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for identifying a communicant in a communication according to an aspect of the subject matter described herein;

FIG. 3 is a block diagram illustrating an arrangement of components for identifying a communicant in a communication according to an aspect of the subject matter described herein;

FIG. 4a is a block diagram illustrating an arrangement of components for identifying a communicant in a communication according to an aspect of the subject matter described herein;

FIG. 4b is a block diagram illustrating an arrangement of components for identifying a communicant in a communication according to another aspect of the subject matter described herein;

FIG. 4c is a block diagram illustrating an arrangement of components for identifying a communicant in a communication according to another aspect of the subject matter described herein;

FIG. 5 is a network diagram illustrating an exemplary system for identifying a communicant in a communication according to an aspect of the subject matter described herein;

FIG. 6a is a diagram illustrating a user interface presented via a display according to an aspect of the subject matter described herein; and

FIG. 6b is a diagram illustrating a user interface presented via a display according to an aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure.

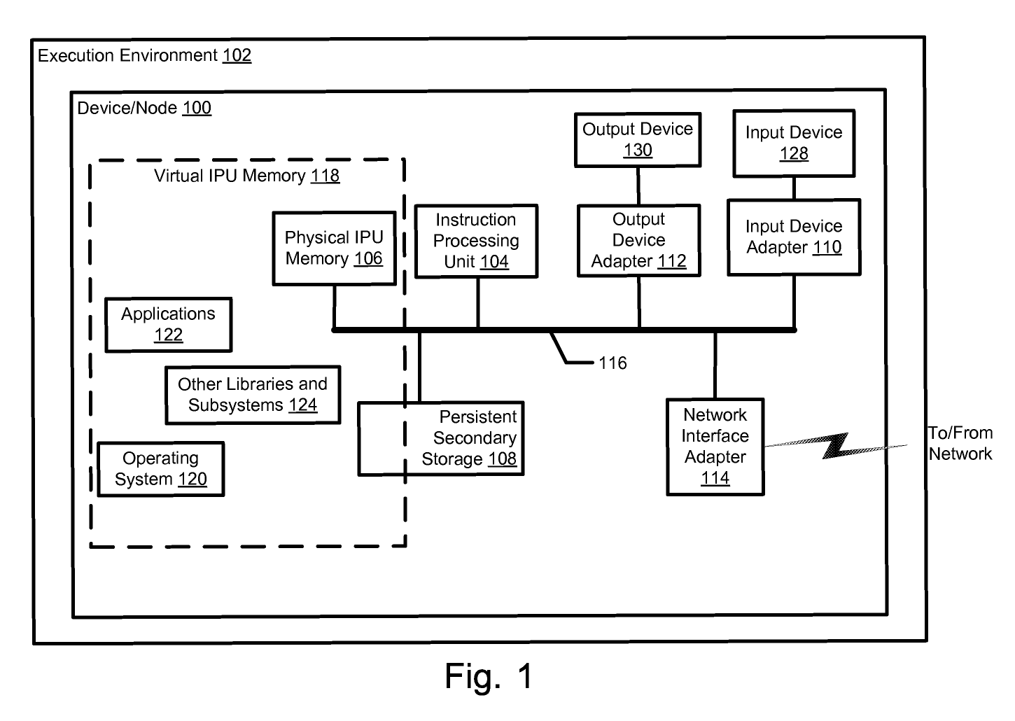

An exemplary device included in an execution environment that may be configured according to the subject matter is illustrated in FIG. 1. An execution environment includes an arrangement of hardware and, optionally, software that may be further configured to include an arrangement of components for performing a method of the subject matter described herein. An execution environment includes and/or is otherwise provided by one or more devices. An execution environment may include a virtual execution environment including software components operating in a host execution environment. Exemplary devices included in or otherwise providing suitable execution environments for configuring according to the subject matter include personal computers, notebook computers, tablet computers, servers, handheld and other mobile devices, multiprocessor devices, distributed devices, consumer electronic devices, routers, communication servers, and/or other network-enabled devices. Those skilled in the art will understand that the components illustrated in FIG. 1 are exemplary and may vary by particular execution environment.

FIG. 1 illustrates hardware device 100 included in execution environment 102. FIG. 1 illustrates that execution environment 102 includes instruction-processing unit (IPU) 104, such as one or more microprocessors; physical processor memory 106 including storage locations identified by addresses in a physical memory address space of IPU 104; persistent secondary storage 108, such as one or more hard drives and/or flash storage media; input device adapter 110, such as a key or keypad hardware, a keyboard adapter, and/or a mouse adapter; output device adapter 112, such as a display or audio adapter for presenting information to a user; a network interface component, illustrated by network interface adapter 114, for communicating via a network such as a LAN and/or WAN; and a communication mechanism that couples elements 104-114, illustrated as bus 116. Elements 104-114 may be operatively coupled by various means. Bus 116 may comprise any type of bus architecture, including a memory bus, a peripheral bus, a local bus, and/or a switching fabric.

IPU 104 is an instruction execution machine, apparatus, or device. Exemplary IPUs include one or more microprocessors, digital signal processors (DSPs), graphics processing units, application-specific integrated circuits (ASICs), and/or field programmable gate arrays (FPGAs). In the description of the subject matter herein, the terms “IPU” and “processor” are used interchangeably. IPU 104 may access machine code instructions and data via one or more memory address spaces in addition to the physical memory address space. A memory address space includes addresses identifying locations in a processor memory. The addresses in a memory address space are included in defining a processor memory. IPU 104 may have more than one processor memory. Thus, IPU 104 may have more than one memory address space. IPU 104 may access a location in a processor memory by processing an address identifying the location. The processed address may be in an operand of a machine code instruction and/or may be identified in a register or other portion of IPU 104.

FIG. 1 illustrates virtual processor memory 118 spanning at least part of physical processor memory 106 and at least part of persistent secondary storage 108. Virtual memory addresses in a memory address space may be mapped to physical memory addresses identifying locations in physical processor memory 106. An address space for identifying locations in a virtual processor memory is referred to as a virtual memory address space; its addresses are referred to as virtual memory addresses; and its processor memory is known as a virtual processor memory or virtual memory. The term “processor memory” may refer to physical processor memory 106 and/or virtual processor memory 118 depending on the context in which the term is used.

Physical processor memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), and/or RAMBUS DRAM (RDRAM). Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include removable media. The drives and their associated computer readable storage media provide volatile and/or nonvolatile storage for computer readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including operating system 120, one or more applications 122, and other program code and/or data components illustrated by other libraries and subsystems 124. In an aspect, some or all software components may be stored in locations accessible to IPU 104 in a shared memory address space shared by the software components. The software components accessed via the shared memory address space are stored in a shared processor memory defined by the shared memory address space. In another aspect, a first software component may be stored in one or more locations accessed by IPU 104 in a first address space and a second software component may be stored in one or more locations accessed by IPU 104 in a second address space. The first software component is stored in a first processor memory defined by the first address space and the second software component is stored in a second processor memory defined by the second address space.

Software components typically include instructions executed by IPU 104 in a computing context referred to as a “process”. A process may include one or more “threads”. A “thread” includes a sequence of instructions executed by IPU 104 in a computing sub-context of a process. The terms “thread” and “process” may be used interchangeably herein when a process includes only one thread.

Execution environment 102 may receive user-provided information via one or more input devices illustrated by input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by IPU 104, physical processor memory 106, and/or other components included in execution environment 102.

Output device 130 in FIG. 1 exemplifies one or more output devices that may be included in and/or may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion producing devices, and other output devices producing sensory information detectable by a user.

A device included in or otherwise providing an execution environment may operate in a networked environment communicating with one or more devices via one or more network interface components. The terms “communication interface component” and “network interface component” are used interchangeably. FIG. 1 illustrates network interface adapter (NIA) 114 as a network interface component included in execution environment 102 to operatively couple device 100 to a network. A network interface component includes a network interface hardware (NIH) component and optionally a software component. The terms “network node” and “node” in this document both refer to a device having a network interface component for operatively coupling the device to a network.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “device” and “node” as used herein refer to one or more devices and nodes, respectively, providing and/or otherwise included in an execution environment unless clearly indicated otherwise.

As used herein, the term “communication” refers to information including a message sent and/or for sending via a network between communicants. The term “communicant” as used herein refers to a user included in a communication as a sender and/or a receiver of the information. A communicant is represented by a “communications agent” configured to operate in an execution environment to send data to and/or receive data from another communications agent, on behalf of the represented communicant, according to a communications protocol via network. A communications protocol defines and/or otherwise identifies an address space including communications addresses for delivering data sent in a communication from one communications agent to another.

The term “communicant alias” as used herein refers to an identifier of a communicant in a communication where the communicant alias is not a communications address included in an address space of a communications protocol for sending and/or receiving data in the communication.

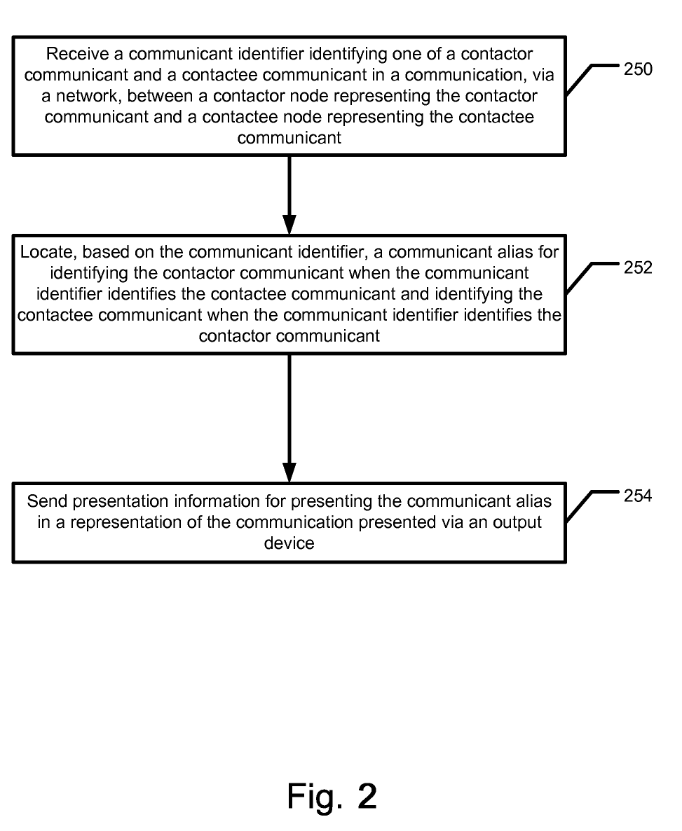

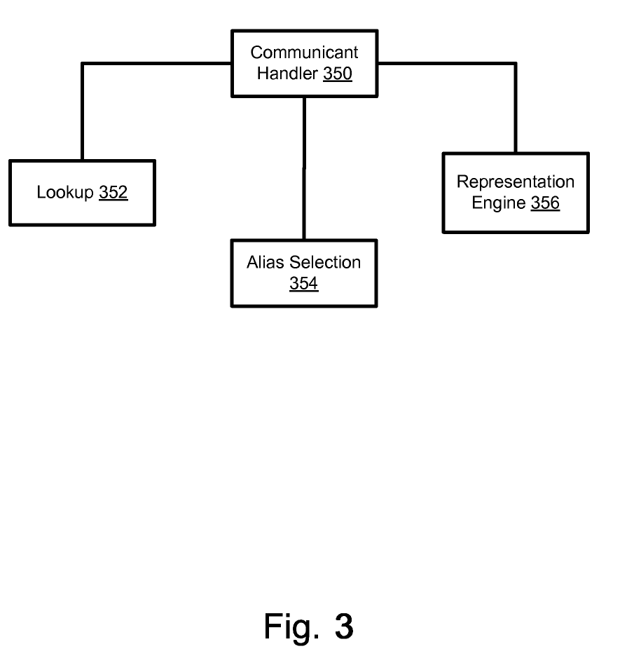

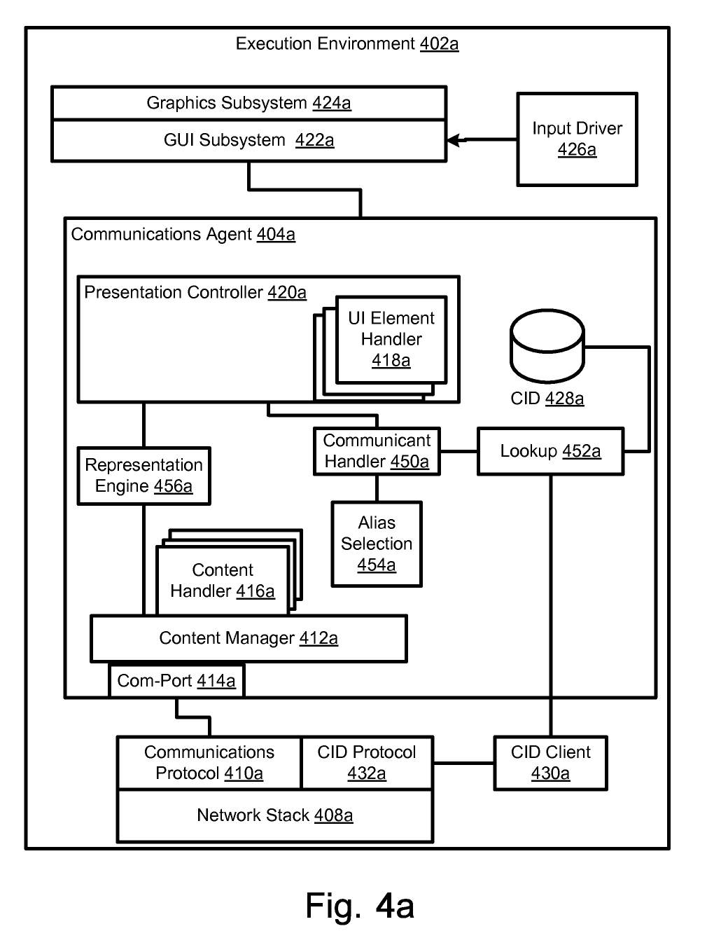

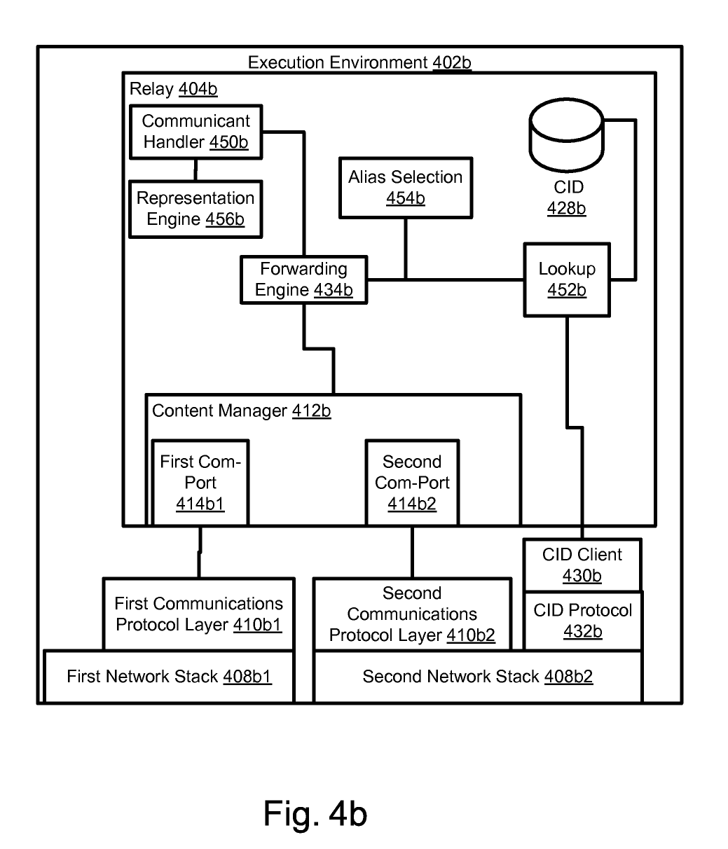

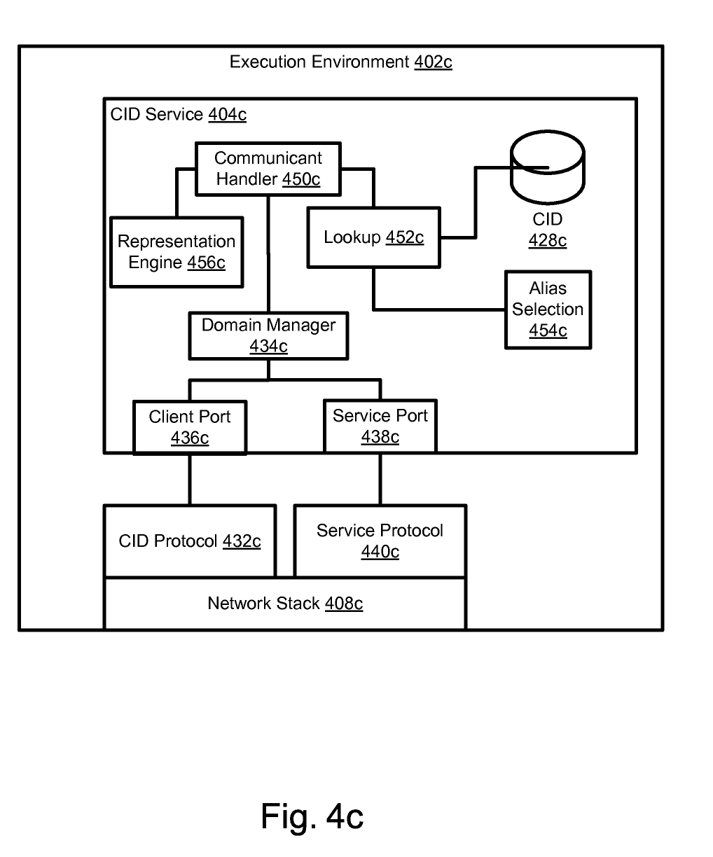

The block diagram in FIG. 3 illustrates an exemplary system for identifying a communicant in a communication according to the method illustrated in FIG. 2. A system for performing the method illustrated in FIG. 2 includes an execution environment, including an instruction-processing unit, configured to process an instruction included in at least one of a communicant handler component 350, a lookup component 352, and a representation component 354 illustrated in FIG. 3. Some or all of the exemplary components illustrated in FIG. 3 may be adapted for performing the method illustrated in FIG. 2 in a number of execution environments. FIG. 4a, FIG. 4b, and FIG. 4c each illustrate block diagrams including the components of FIG. 3 and/or analogs of the components of FIG. 3, respectively, adapted for operation in execution environment 402a, execution environment 402b, and execution environment 402c.

Execution environments and components of execution environments illustrated in FIG. 4a, FIG. 4b, and FIG. 4c are identified by numbers including postfixes “a”, “b”, and “c”, respectively, to identify a component in a particular figure. The execution environments and included components are identified as a group and/or generically by the identifiers without the postfixes. For example, execution environment 402 may refer to all of the execution environments in FIG. 4a, FIG. 4b, and FIG. 4c and/or may refer generically to any execution environment that includes an adaptation and/or analog of an arrangement of components for performing the method illustrated in FIG. 2.

FIG. 1 illustrates components of an exemplary node that may at least partially provide and/or otherwise be included in an execution environment. The components illustrated in FIG. 4a, FIG. 4b, and FIG. 4c may be included in or otherwise combined with the components of FIG. 1 to create a variety of arrangements of components according to the subject matter described herein.

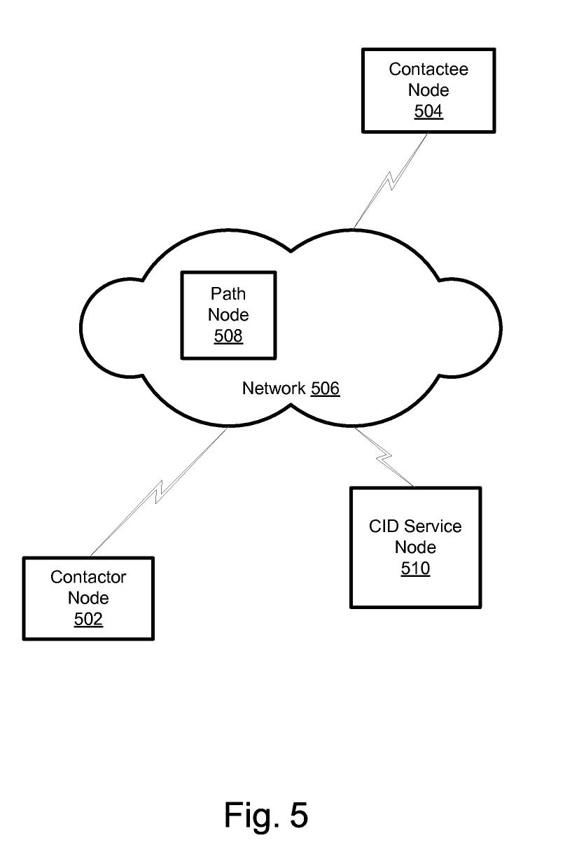

FIG. 5 illustrates contactor node 502 as an exemplary device included in and/or otherwise adapted for providing execution environment 402a in FIG. 4a. As illustrated in FIG. 5, contactor node 502 and contactee node 504 are operatively coupled to network 506 via respective network interface components enabling contactor node 502 and contactee node 504 to exchange data in a communication on behalf of communicants represented and/or included in the respective nodes. FIG. 5 also illustrates path node 508 in network 506. Path node 508 illustrates a node in a network path for operatively coupling contactor node 502 and contactee node 504, in an aspect of the subject matter described herein. Path node 508 may be included in and/or otherwise adapted for providing execution environment 402b in FIG. 4b. FIG. 5 further illustrates communicant information directory (CID) service node 510 in network 506. CID service node 510 may host a CID service adapted for performing the method illustrated in FIG. 2. CID service node 510 may be included in and/or otherwise adapted for providing execution environment 402c in FIG. 4c.

FIG. 4a illustrates execution environment 402a hosting communications agent 404a. Communications agent 404a in FIG. 4a illustrates a communications agent that may represent a contactor communicant, also referred to as a “contactor”, in a communication and may represent a contactee communicant, also referred to as a “contactee” in a communication. The terms “contactor” and “contactee” identify roles in a communication. A “contactor” provides information for identifying a “contactee” in a communication. A contactee may be included in a communication by a contactor and/or the contactor's communications agent. A contactor and/or a contactee is a user of a communications agent and may be a living being, a node, a component, and/or an application. Both a contactor and a contactee are communicants in a communication.

Components in FIG. 4a are referenced in some locations in the description herein to describe a communications agent operating in an execution environment of contactor node 502 and are referenced in some locations to describe a communications agent operating in an execution environment of contactee node 504. Exemplary communications agents include email clients, phone clients including Voice over Internet Protocol (VoIP) clients, instant messaging clients, short message service (SMS) clients, multimedia message service (MMS clients), and/or other multimedia communications clients including video-phone clients.

Communications agent 404a in FIG. 4a includes an adaptation of the arrangement of components in FIG. 3. Communications agent 404a may operate, in contactor node 502, on behalf of a contactor to communicate with a contactee represented by a communications agent operating in contactee node 504.

FIG. 4b illustrates relay component 404b configured to operate on behalf of contactor node 502 in FIG. 5, of communications agent 404a in contactor node 502, and/or of the contactor represented by communications agent 404a operating as contactor(s) with respect to relay component 404b. FIG. 4b illustrates another adaptation of the arrangement of components in FIG. 3 operating in relay component 404b. Exemplary relay components include email gateways, instant messaging relays, and voice switches that may operate in path nodes servicing communications agents, such as those listed in the previous paragraph.

FIG. 4c illustrates CID service 404c configured to provide directory services for maintaining and locating aliases and/or communications addresses for one or more communicants. FIG. 4c illustrates an adaptation of the arrangement of components in FIG. 3 operating in CID service 404c. In an aspect, CID service node 510 and CID service 404c may operate in a system of nodes in a CID system where each node provides directory services for a portion of the CID system. A CID service system may have a peer-to-peer organization and/or a hierarchical organization. For illustrative purposes, CID service 404c is described herein as providing directory services for one or more domains defined in a CID system. A domain defines at least one of a format and a vocabulary for identifiers in the domain where an identifier may be an alias and/or a communications address according to the particular domain.

As stated, the various adaptations of the arrangement in FIG. 3 illustrated and described herein are not exhaustive. For example, those skilled in the art will understand based on the description herein that arrangements of components for performing the method illustrated in FIG. 2 may be distributed across more than one node and/or execution environment. For example, such an arrangement may operate at least partially in a user node such as contactor node 502 and at least partially in a relay node such as path node 508.

FIG. 4a, FIG. 4b, and FIG. 4c illustrate network stacks 408 configured for sending and receiving data in communications via network 506 in FIG. 5. Contactor node 502, contactee node 504, path node 508, and CID service node 510 may be operatively coupled to network 506 via respective network interface components. In an aspect, one or more communications between contactor node 502 and contactee node 504 may operate via path node 508 via the operation of relay component 404b. The network stacks 408 in contactor node 502, contactee node 504, path node 508, and CID service node 510 may support some or all of the same protocol suite, such as TCP/IP, or may communicate via a network gateway or other protocol translation device and/or service.

Relay component 404b in path node 508, in an aspect, may operate as a protocol gateway. In another aspect, delivery of a communication between contactor node 502 and contactee node 504 may not include path node 508. Network 506 may include a direct physical layer link between contactor node 502 and contactee node 504. Contactor node 502 and contactee node 504 may communicate via one or more nodes, in network 506, that operate without knowledge of a communications protocol for communicating between communications agents that are operating, respectively, in contactor node 502 and in contactee node 504. For example, a layer-2 switch or a layer-3 router may operate below a communications protocol layer that may operate at and/or otherwise may operate in a session layer, presentation layer, and/or application layer of a network.

Communications agents in contactor node 502 and in contactee node 504 in FIG. 5 may interoperate via their respective network stacks 408. The communications agents may communicate via one or more communications protocols. Communications agent 404a in FIG. 4a illustrates communications protocol component 410a illustrating a subsystem for communicating via network 506 according to one or more communications protocols, such as simple mail transfer protocol (SMTP); an instant messaging protocol, such as XMPP-IM; and/or a real-time voice and/or video protocol, such as real-time transport protocol (RTP). A communication between communications agents, respectively, operating in contactor node 502 and contactee node 504 may include more than one type of data or content type and may use one or more communications protocols for communicating the one or more content types via network 506.

FIG. 4b illustrates that relay component 404b in path node 508 may communicate with communications agents in contactor node 502 and contactee node 504, respectively, via one or more communications protocols through the operation of one or more communications protocol components 410b. Communications protocol component(s) 410b may be configured to interoperate with network stack(s) 408b to communicate via network 506. FIG. 4b illustrates communications protocol component 410b as including a first communications protocol component 410b1 for communicating with a communications agent in contactor node 502 via first network stack 408b1. FIG. 4b also illustrates communications protocol component 410b as including a second communications protocol component 410b2 for communicating with a communications agent in contactee node 504 via second network stack 408b2.

In various aspects a path node may include one or more network stacks, one or more communications protocol layers, and/or one or more network interface components. In FIG. 4b, first network stack 408b1 and second network stack 408b2 may include components for communicating via the same and/or different physical layer protocol(s), link layer protocol(s), network layer protocol(s), and/or other protocol(s) to support a communications protocol. Analogously, first communications protocol component 410b1 and second communications protocol component 410b2 may support one or more communications protocols. First communications protocol component 410b1 may operate according to the same communications protocol(s) as second communications protocol component 410b2. Alternatively or additionally, first communications protocol component 410b1 may operate according to one or more different communications protocol(s) than second communication protocol component 410b2.

Whether a communication from communications agent 404a in contactor node 502 is delivered to the communications agent in contactee node 504 via relay component 404b in path node 508 or not, data in the communication may be exchanged via discrete packets, a request/reply protocol, a data-streaming protocol, a session-oriented and/or connection-oriented protocol, a connectionless protocol, a real-time communications protocol, an asynchronous communication, a store and forward communications protocol, a reliable delivery communications protocol, a best-effort delivery communications protocol, a secure protocol and/or an unsecure protocol; to name a few communications options available according to various communications protocols.

FIG. 4c illustrates that CID service node 510 may interoperate with contactor node 502, contactee node 504, path node 508, and/or another CID service node via network stack 408c and network 506. FIG. 4c illustrates CID protocol component 432c for receiving directory requests and sending responses to the requests to CID clients 430 in FIG. 4a and FIG. 4b. Alternatively or additionally, CID protocol component 432c may send and/or receive asynchronous messages via network 506 in interoperating with CID clients 430 in FIG. 4a and FIG. 4b. When CID service 404c is included in a federated CID system, execution environment 402c may include service protocol component 440c for interoperating with other CID service nodes in the CID system according to specifications of the service protocol.

FIG. 4a illustrates communications agent 404a including content manager component 412a. Content manager component 412a may interoperate with communications protocol layer component 410a and/or network stack 408a to receive data in one or more communications via network 506 with another communications agent in another node. Content manager component 412a is operatively coupled, via com-port component 414a, to communications protocol component 410a for receiving the data from the other node.

Data received in a communication may include data with one or more content types. Exemplary content types include plain text, markup such as hypertext markup language (HTML), audio data, image data, and/or executable data such as script instruction(s), byte code, and/or machine code. In FIG. 4a, communications agent 404a includes one or more content handler components 416a to process data received according to its content type.

A data type may be identified by a MIME type identifier and/or other schema identifier. Exemplary content handler components 416a include a text/html content handler component for processing HTML representations; an application/xmpp-xml content handler component for processing XMPP streams including presence tuples, instant messages, and audio content handlers including and/or configured to retrieve suitable codices; one or more video content handler components for processing video representations of various types; and still image data content handler components for processing various image data representations. Content handler component(s) 416a process received data representations and may provide transformed data from the representations to one or more user interface element handler components 418a described in more detail below.

One or more user interface element handler components 418a are illustrated in presentation controller component 420a in FIG. 4a. Presentation controller component 420a may manage visual, audio, and other types of output for its including application as well as receive and route detected user and other inputs to components and extensions of its including application, communications agent 404a. With respect to FIG. 4a, a user interface element handler component 418a may be adapted to operate at least partially in a content handler component 416a such as a text/html content handler component and/or a script content handler component. Additionally or alternatively, a user interface element handler component in execution environment 402a may be received in a communication. For example, a communication, such as an email, may include an HTML content type portion and a script content type portion.

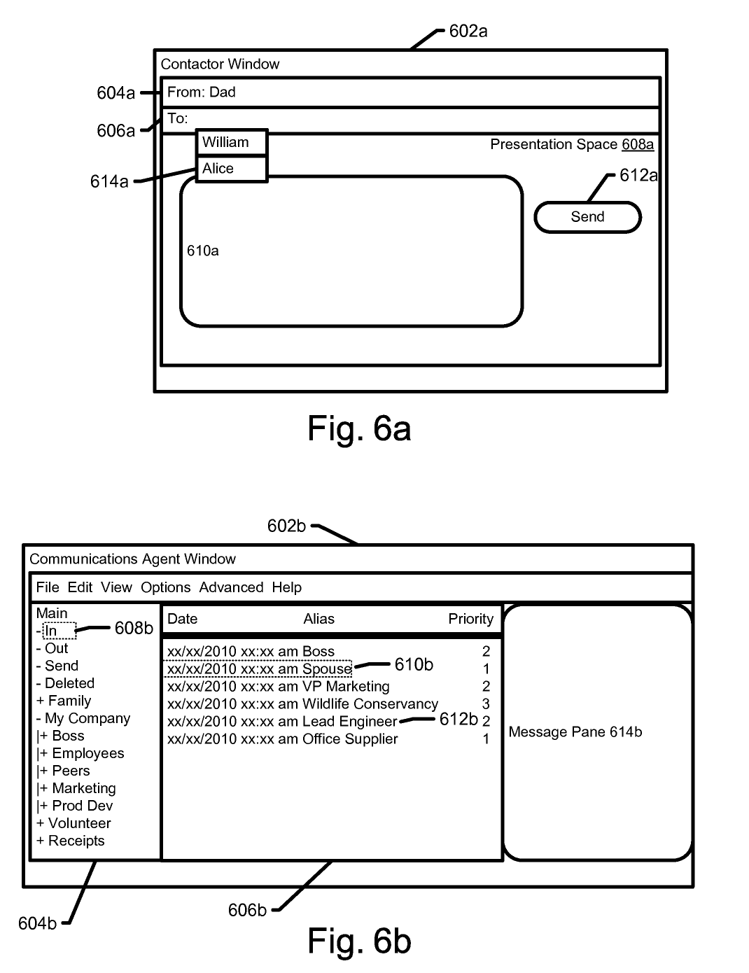

FIG. 6a illustrates an exemplary contactor window 602a presented by communications agent 404a in a presentation space of a display device, such as output device 130 in FIG. 1. Contactor window 602a includes a contactor user interface (UI) element 604a for presenting a contactor identifier of a contactor included in a communication represented by contactor window 602a. Contactor window 602a also includes a contactee UI element 606a for presenting one or more contactee identifier(s) identifying one or more contactee(s) included in the communication. Presentation space 608a is provided by contactor window 602a for presenting a message UI element 610a for presenting a message in the communication addressed to one or more contactees in contactee UI element 606a. Presentation space 608a may also be provided for presenting one or more UI controls for exchanging data in and/or otherwise managing a communication. Send UI element 612a illustrates an exemplary UI control for sending data in the communication to one or more identified contactees.

The components of a user interface are generically referred to herein as user interface elements. More specifically, visual components of a user interface are referred to herein as visual interface elements. A visual interface element may be a visual component of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the exemplary elements listed. Those skilled in the art will understand that this list is not exhaustive. The terms “visual representation”, “visual component”, and “visual interface element” are used interchangeably in this document. Other types of user interface elements include audio output components referred to as audio interface elements, tactile output components referred to as tactile interface elements, and the like.

A “user interface (UI) element handler” component, as the term is used in this document, includes a component configured to send information representing a program entity for presenting a user detectable representation of the program entity by an output device, such as a display. A “program entity” is an object included in and/or otherwise processed by an application or executable program component. The user detectable representation is presented based on the sent information. The sent information is referred to herein as “presentation information”. Presentation information may include data in one or more formats including image formats such as JPEG, video formats such as MP4, markup language data such as HTML and other markup based languages, and/or instructions such as those defined by various script languages, byte code, and/or machine code. For example, a voice communication for receiving by a communications agent and/or for sending by a communications agent may be included in a media container having a specified format, such as MPEG4, and may be compressed, encrypted, and/or otherwise encoded. The data is communicated for presenting in and/or by one or more user interface elements included in a user interface of a communications agent. Components configured to send information representing one or more program entities for presenting particular types of output by particular types of output devices include visual interface element handler components, audio interface element handler components, tactile interface element handler components, and the like.

A representation of a program entity may be represented and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space. A presentation space may be physically and/or logically contiguous or non-contiguous. A presentation space may have a virtual as well as a physical representation. A presentation space may include a storage location in processor memory, secondary storage, a memory of an output device adapter device, and/or a storage medium of an output device. A screen of a display, for example, is a presentation space.

As used herein, the terms “program”, “program component”, “application”, “application component”, “executable” and “executable component” refer to any data representation that may be translated into a set of machine code instructions and optional associated program data. Thus, a program or executable may include an application, a shared or non-shared library, and a system command. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which the term “object code” is used will make clear the state of the object code when it is relevant.

Various user interface elements illustrated in FIG. 6a presented by communications agent 404a in FIG. 4a may be presented by one or more user interface element handler components 418a. User interface element handler component(s) 418a in FIG. 4a may send presentation information representing visual interface element(s), such as contactor UI element 604a in FIG. 6a, to GUI subsystem 422a. GUI subsystem 422a may instruct graphics subsystem 424a to draw the visual interface element(s) in a region of a display device included in execution environment 402a of contactor node 502 based on the presentation information received in and/or generated from data received in the communication.

Input may be received via input driver 426a in FIG. 4a. For example, a user may move a mouse to move a pointer presented in a display of contactor node 502 over send UI element 612a. The user may provide an input detected by the mouse. The detected input may be received by GUI subsystem 422a via input driver 426a as a send command indicator based on the association of the shared location of the pointer and the send UI element 612a in the presentation space of the display.

Data to send in a communication to a communications agent in contactee node 504 may be received by one or more content handler component(s) 416a operating in contactor node 502 to transform the data into one or more representations suitable for transmitting in the communication and/or suitable for processing by the communications agent in contactee node 504. The one or more data representations may be provided to content manager component 412a for sending in the communication to contactee node 504. Content manager component 412a may include the one or more data representations in a message formatted according to the communications protocol according to which communications protocol component 410a operates; Communications protocol component 410a may send the data according to the specification(s) of the communications protocol. Content manager component 412a may alternatively or additionally encode and/or otherwise transform one or more of the data representations for sending in a data stream such as a voice stream and/or a video stream for communicating in the communication to the communications agent.

Content manager component 412a operating in execution in environment 402a included in and/or otherwise provided by contactor node 502 may provide the packaged, encoded, and/or transformed data to communications protocol component 410a via com-port component 414a. Com-port component 414a illustrates a component in communications agent 404a for operatively coupling communications agent 404a to communications protocol component 410a according to an interface provided by communications protocol component 410a for sending and/or receiving data in a communication according to a communications protocol. Communications protocol component 410a may further package and/or otherwise transform the data to send via network stack 408a for delivery via network 506 to contactee node 504.

As described above, a communications protocol may operate via one or more nodes in a network in a network path including a contactor node and a contactee node. Exemplary path nodes include mail relay nodes, phone switch nodes, and proxy nodes such as instant messaging proxies for communicating through firewalls. As indicated, path node 508 including and/or otherwise providing execution environment 402b illustrates such a node. Data in a communication from contactor node 502 may be received via first network stack 408b1 and first communications protocol component 410b1 from network 506. First communications protocol component 410b1 may strip off communications protocol information, un-package, repackage, and/or otherwise transform data received in the communication for routing to content manager component 412b. In an aspect, a contactee address in an address space of the communications protocol may be included and/or otherwise identified by the communication.

Content manager component 412b may provide information to forwarding engine component 434b for determining a route to relay the data received in the communication to contactee node 504. Forwarding engine component 434b may determine some or all of a route to contactee node 504 according the communications protocol and/or based on a separate routing protocol. Based on the determination by forwarding engine component 434b, content manager component 412b may determine a next node in a network path for delivering the data to contactee node 504 and/or may identify a network interface component for sending the data in the communication to a next node. Content manager component 412b may identify second com-port component 414b2 for relaying the data to the next node. The next node may be contactee node 504 or may be another path node. Second com-port 414b2 may interoperate with second communication protocol component 410b2 to relay the data in the communication to network 506 for delivery to the communications agent in contactee node 504.

With reference to FIG. 2, block 250 illustrates that the method includes receiving a communicant identifier identifying one of a contactor communicant and a contactee communicant in a communication, via a network, between a contactor node representing the contactor communicant and a contactee node representing the contactee communicant. Accordingly, a system for identifying a communicant in a communication includes means for receiving a communicant identifier identifying one of a contactor communicant and a contactee communicant in a communication, via a network, between a contactor node representing the contactor communicant and a contactee node representing the contactee communicant. For example, as illustrated in FIG. 3, communicant handler component 350 is configured for receiving a communicant identifier identifying one of a contactor communicant and a contactee communicant in a communication, via a network, between a contactor node representing the contactor communicant and a contactee node representing the contactee communicant. FIG. 4a, FIG. 4b, and FIG. 4c illustrate communicant handler components 450 as adaptations and/or analogs of communicant handler component 350 in FIG. 3. One or more communicant handler components 450 operate in each of execution environments 402 in FIG. 4a, FIG. 4b, and FIG. 4c.

In one aspect, a communicant identifier of a communicant may be received via an input device from a communicant represented by a communications agent in a user node. In FIG. 4a, presentation controller 420a and/or a UI element handler 418a presenting and/or managing interaction with contactor UI element 604a or contactee UI element 606a in FIG. 6 for contactor node 502 may receive a communicant's name, an alias for the communicant, and/or address information identifying a communicant's address for the communicant. Regardless of the identifier space of the communicant identifier, the communicant identifier may identify a communications address for the communicant.

The communicant identifier may be received by communications agent 404a operating in contactor node 502 in response to a user input. In FIG. 6a, the user input may correspond to contactor UI element 604a or contactee UI element 606a. Additionally or alternatively, a communicant identifier may be received by communications agent 404a in response to a user input processed by another application, such as an address book application (not shown). The user of contactor node 502 may enter a communicant identifier, such as “Dad”, via a keyboard and/or may select a predefined communicant identifier presented in a selection control UI element (not shown) by a UI element handler component 418a. The user input may be detected by, for example, input driver 426a. Corresponding input information may be routed to presentation controller 420a by GUI subsystem 422a as described above.

The input may be provided to communicant handler component 450a formatted and encoded according to an interface operatively coupling presentation controller component 420a and communicant handler 450a. Communicant handler 450a may look up additional information identified by the received communicant identifier. For, example, communicant handler component 450a may retrieve the additional information from a directory or database based on the received communicant identifier.

FIG. 4a illustrates a communicant information directory (CID) 428a accessed by communicant handler component 450a via lookup component 452a. A local CID may be a stand-alone directory and/or may be included in a CID system of federated directories, for example as a cache. The additional information may include one or more communications addresses from one or more communications address spaces of one or more communications protocols for various types of communications. The additional information may include a name for the contactor that communications agent 404a may present in contactor UI element 604a and/or include in the communication.

Additionally or alternatively, some or all of the additional information may be maintained by CID service node 510 and accessed via CID client component 430a. CID client component 430a may interoperate with a CID service operating in CID service node 510 via CID protocol component 432a according to a protocol specification for accessing and providing CID services over a network.

In another aspect, a communicant identifier may be received via a network from a component and/or node operating in the role of a contactor or operating on behalf of a contactor. In FIG. 4b, content manager component 412b operating in path node 508 may receive a communicant identifier in data sent in a communication from contactor node 502. The data may be sent to initiate a communication session and/or connection when required by the communications protocol, such as a voice communication between a contactor communicant and a contactee communicant. Not all communications require a session and/or connection between contactor node 502 and contactee node 504. For example, data may be sent in an email communication where a session between the email contactor node and the email contactee node is not required.

The communicant identifier may be received from network 506 via network stack 408 and by communications protocol component 410. Content manager component 412b in FIG. 4b may include one or more com-port components 414b for sending and receiving data in various communications received and sent via one or more communications protocol component(s) 410b. For example, path node 508 may include a network interface component physically coupled to a first portion of network 506 including contactor node 502 and another network interface component physically coupled to a second portion of network 506 including contactee node 504. Data including a communicant identifier may be received by content manager component 412b via first com-port component 414b1.

As described above, content manager component 412b may invoke forwarding engine component 434b to determine one or more routes for relaying the received data and/or for sending data for establishing a session and/or connection with a contactee node. When a communicant identifier is received in data from a contactor node, forwarding engine component 434b may provide and/or otherwise identify the communicant identifier to communicant handler component 450b. Communicant handler component 450b may receive the communicant identifier as received by content manager component 412b and/or transformed by content manager component 412b, forwarding engine component 434b, and/or other component(s) in execution environment 402b included in processing the communicant identifier.

Communicant handler component 450b may look up additional information based on the communicant identifier as described with respect to communicant handler component 450a above. Communicant handler component 450b may retrieve the additional information from local CID 428b accessed by communicant handler component 450b via lookup component 452b. Additionally or alternatively, some or all of the additional information may be maintained by CID service node 510 and accessed by lookup component 452b via CID client component 430b in a manner analogous to that described above with respect to CID client component 430a in FIG. 4a.

In yet another aspect, a communicant identifier may be received via a network from a component and/or node operating in the role of a client of a CID service. In FIG. 4c, communicant handler component 450c may receive a communicant identifier via a query and/or request from a CID client 430 illustrated in FIG. 4a and FIG. 4b. The communicant identifier may be received via a protocol specified for accessing CID services described above. CID protocol components 432 in FIG. 4a, FIG. 4b, and FIG. 4c may be configured to communicate according to the specification of the CID protocol.

The received data including the communicant identifier may be provided to client port component 436c included in CID service 404c. Client port component 436c may communicatively couple CID service 404c to one or nodes including CID clients 430. One or more requests or queries may be received, via the communicative coupling, from one or more CID protocol components 432, illustrated in FIG. 4a and FIG. 4b. The one or more requests may be received via CID protocol component 432c. CID protocol component 432c may unpack, package, decode, encode, and/or otherwise transform a request to provide request information based on the request to domain manager component 434c. Domain manager component 434c, in an aspect, may determine whether a response to a received request may be generated from information in a domain managed by the CID service 404c. The determination may be made based on the communicant identifier and/or based on information requested.

In a further aspect, when domain manager component 434c determines that the request is associated with another domain of another CID service node, domain manager component 434c may forward some or all of the request for delivery to a CID service node managing the other domain to respond to the request. The request may be forwarded according to a protocol for interoperation between and/or among CID service nodes in a CID system. Service port component 438c operatively couples CID service 404c to service protocol component 440c. Service protocol component 440c may exchange data with one or more other CID service nodes according to the specified service protocol via network stack 408c.

Thus, a communicant identifier may be received by communicant handler component 450c via a message from another CID service node via service protocol component 440c, service port component 438c, and domain manager component 434c as illustrated by the arrangement of components in FIG. 4c.

Returning to FIG. 2, block 252 illustrates that the method further includes locating, based on the communicant identifier, a communicant alias for identifying the contactor communicant when the communicant identifier identifies the contactee communicant and identifying the contactee communicant when the communicant identifier identifies the contactor communicant. Accordingly, a system for identifying a communicant in a communication includes means for locating, based on the communicant identifier, a communicant alias for identifying the contactor communicant when the communicant identifier identifies the contactee communicant and identifying the contactee communicant when the communicant identifier identifies the contactor communicant. For example, as illustrated in FIG. 3, lookup component 352 is configured for locating, based on the communicant identifier, a communicant alias for identifying the contactor communicant when the communicant identifier identifies the contactee communicant and identifying the contactee communicant when the communicant identifier identifies the contactor communicant. FIG. 4a, FIG. 4b, and FIG. 4c illustrate lookup components 452 as adaptations and/or analogs of lookup component 352 in FIG. 3. One or more lookup components 452 operate in each of execution environments 402 in FIG. 4a, FIG. 4b, and FIG. 4c.

In addition to and/or instead of retrieving some or all of the additional information for the communicant identifier, communicant handler component 450a may identify and/or otherwise provide access to the received communicant identifier to lookup component 452a to locate a communicant alias of a communicant. The communicant alias may identify a communications address for the identified communicant. The communications address may already be included in the communication or not yet included in the communication. Lookup component 452a may locate the communicant alias by identifying a record and/or other data storage entity in CID 428 that includes and/or otherwise identifies the communicant identifier and that also includes and/or otherwise identifies the communicant alias. The communicant alias may identify a contactee communicant or a contactor communicant. The communicant alias may identify one or more communications addresses for the identified communicant.

FIG. 6a illustrates an aspect in which multiple communicant aliases are located and/or otherwise identified based on a received communicant identifier. The communicant aliases may be located by determining that they meet a matching condition based on the communicant identifier. In FIG. 4a, CID 428a may include a contact list identified by a received communicant identifier. The communicant identifier may be a communications address or may be a communicant alias, such as “Dad”, identifying the communications address for the communicant identified by the communicant identifier. The contact list may include communicant entries for one or more communicants that interact with the communicant identified by the received communicant identifier according to a role, rank, and/or other relationship identified by the communicant identifier. For example, a contact list identified by the communicant identifier “Dad” may include communicant entries for communicants that interact with the communicant identified by “Dad” as a father and/or as their father. FIG. 6a illustrates a communicant selection list 614a presenting names of children of the communicant identified by the communicant identifier “Dad”. The names may be communicant aliases for communications addresses for the respective children communicants.

As described above, relay component 404b in FIG. 4b may receive a communicant identifier from contactor node 502, the communications agent in contactor node 502, and/or the communicant represented by the communications agent in contactor node 502 that may operate as contactor(s) with respect to relay component 404b. Relay component 404b may locate, based on the communicant identifier, a communicant alias. For example, relay component 404b may determine that a matching condition based on the communicant identifier is met by the communicant alias.

Communicant handler component 450b in FIG. 4b may identify and/or otherwise provide access to the received communicant identifier to lookup component 452b to locate a communicant alias. Lookup component 452b may, in an aspect, identify a record and/or other stored data entity including and/or otherwise identifying the communicant alias in CID 428b. The record and/or other stored data entity may include and/or otherwise identify the received communicant identifier. The communicant alias may identify a communications address for a contactee communicant or a contactor communicant. The communicant alias may identify one or more communications addresses.

In an aspect, a single communicant alias may be located based on the received communicant identifier. For example, a contactee communicant alias “Boss” may be configured by an administrator of path node 508 and/or CID service node 510 in an organization for identifying the manager of all or any number of employees in a company. A record may be maintained for a first communicant who is managed by a second communicant in the company. A communicant identifier of the first communicant, “Employee”, may identify a record including the “Boss” communicant alias and a communications address of the communicant identified by “Boss” for the employee. “Boss” records for one or more employees may be maintained in a directory server accessible to path node 508 such as CID 428b and/or CID service node 510. FIG. 4c illustrates CID client component 430b for accessing CID service 404c operating in CID service node 510.

FIG. 4c illustrates that CID service 404c includes lookup component 452c as an adaptation of lookup component 352 in FIG. 3. Communicant handler component 450c may invoke and/or otherwise provide the communicant identifier received in a query and/or request from CID client component 430 in FIG. 4a and/or FIG. 4b operating respectively in contactor node 502 and/or in path node 508 to lookup component 452c to locate a communicant alias. Lookup component 452c may access CID 428c for a domain managed by CID service 404c to locate the communicant alias by determining that a specified matching condition based on the communicant identifier is met. As described above, if the request identifying the communicant identifier is not associated with a domain managed by CID service 404c, domain manager component 434c may forward the request for delivery to a CID service node that manages a domain including the communicant identifier and/or a domain including the communicant alias.

In FIG. 4a, FIG. 4b, and FIG. 4c, alias selection component 454 may automatically identify and select one or more communicant aliases located based on a received communicant identifier as determined by lookup component 452. In the example above where the communicant alias “Boss” is associated with an employee communicant's manager, alias selection component 454 may automatically select the communicant's manager for a communication by including a communications address identified by the “Boss” communicant alias identifying the manager communicant in the communication. The communications address of the manager identifies a communications agent representing the manager.

The communications address may be determined automatically based on the communications agent. For example, if the communications agent is an email client, a business email address of the communicant's manager may be automatically selected.

When a received communicant identifier identifies a contactor, the located communicant alias is selected as a contactee identifier identifying a contactee in the communication. For example, the communicant identifier received may be a communicant alias, “Employee”, identifying the contactor. “Employee” identifies a business communications address for the contactor based on, for example, an address book entry for the contactor. “Employee” may also identify a record identifying “Boss” as communicant alias based on the employee-boss roles of the communicants. “Boss” may be automatically selected as a contactee alias identifying the employee's manager as a contactee of the communication. Records and/or other data identifying an association between a communicant identifier and communicant alias may be maintained in CID 428 in contactor node 502, contactee node 504, path node 508, and/or CID service node 510. The “Boss” communicant alias may be in a record identifying a business communications address of the contactor's manager and/or supervisor. The business communications address of the contactee may be included in response to locating the communicant alias for the contactee.

In an aspect, the business communications address of the contactee communicant may be included in the communication prior to locating the contactee communicant alias. The contactee communication alias may be located based on the received communicant identifier of the contactor and the communications address of the contactee.

When the communicant identifier of the first communications address identifies a contactee, the located communicant alias is selected as a contactor identifier identifying the contactor in the communication. For example, the communicant identifier received may be the communicant alias, “Employee”, identifying communications addresses of one or more contactees. “Employee” may identify a business communications address for the one or more contactees. One or both of “Employee” and the business communications address of the contactee communicant may be received as the communicant identifier. “Employee” and/or the business communications address may also match a key or identifier for a record identifying “Boss” as a communicant alias related to and/or otherwise associated with the communications identifier “Employee” and/or the business communications address. A lookup component 452 may locate the “Boss” communicant alias via CID 428 in contactor node 502, in contactee node 504, and/or in path node 508. “Boss” may identify a business communications address to include in the communication as the contactor's communications address.

In an aspect, the business communications address of the contactor communicant may be included in the communication prior to locating the contactor communicant alias. The contactor communicant alias may be located based on the received communicant identifier of the contactee and the communications address of the contactor.

In another aspect, alias selection component 454 may select a located communicant alias in response to a user input. In FIG. 6a, a user input for selecting “William” may be detected by a UI element handler component for contactee selection list 614a or for a contactor selection list (not shown). A communicant alias selected in response to a user input may be identified to alias selection component 454 to identify a communicant in the communication as a contactee or a contactor based on a relationship between the communicants identified based on the received communicant identifier. As described above a located communicant alias may identify a communications address for the communicant identified by the communicant alias. In another aspect described above, a communicant alias may be located and/or selected for and/or based on a communications address already included in the communication to identify a context or domain for the communication, and/or a relationship between the communicants. For example, “Dad” when included as a communicant alias for a contactor and/or contactee identifies a domain defined by a family and identifies a role played by the communicant identified by “Dad”.

A communicant may have more than one communications address that is suitable for a particular communication. Alias selection component 454 in contactor node 502, contactee node 504, path node 508, and/or CID service node 510 may interoperate with a presentation controller component 420a in contactor node 502 and/or contactee node 504 to receive a user input identifying one or more of the communications addresses for including a communications address for the located and/or otherwise selected communicant alias.

Alias selection component 454 may automatically identify a communications address from multiple communications addresses for a communicant based on the received communicant identifier. “Dad” not only identifies role of the first communicant. “Dad” may identify a communications relationship. Alias selection component 454 may select a home or family communications address for “William”.

When an ambiguity is detected and automatic selection is not possible and/or is otherwise not supported, alias selection component 454 in contactor node 502, contactee node 504, path node 508, and/or CID service node 510 may interoperate with presentation controller 420a in contactor node 502 and/or contactee node 504 to receive user input to resolve the ambiguity, may select multiple communications addresses in response to the ambiguity, and/or may select one or more communications addresses based on a configured policy. A policy may be based on random criterion, an order of a communicant alias and/or communications address in a plurality of communications identifiers, a frequency of use of a communications address, and/or any other suitable criterion.

Returning to FIG. 2, block 254 illustrates that the method yet further includes sending presentation information for presenting the communicant alias in a representation of the communication presented via an output device. Accordingly, a system for identifying a communicant in a communication includes means for sending presentation information for presenting the communicant alias in a representation of the communication presented via an output device. For example, as illustrated in FIG. 3, representation component 354 is configured for sending presentation information for presenting the communicant alias in a representation of the communication presented via an output device. FIG. 4a, FIG. 4b, and FIG. 4c illustrate representation components 454 as adaptations and/or analogs of representation component 354 in FIG. 3. One or more representation components 454 operate in each of execution environments 402 in FIG. 4a, FIG. 4b, and FIG. 4c.

Communications agent 404a operating in contactor node 502 may present a representation of a communication in contactor window 602a as described above. Alternatively or additionally, presentation controller component 420a in contactor node 502 may include one or more UI element handler components 418a to present one or more representations of the communication in a folder such as outbox folder, a sent folder, and/or other folder selected by the first communicant and/or as automatically categorized according to the communications agent 404a configuration. The representation may be sent by representation engine 456a operating in contactor node 502, by representation engine 456b for presenting via an output device of contactor node 502, and/or by representation engine 456c for presenting via an output device of contactor node 502.

When the communicant identifier received is for the contactor, the communicant alias is presented to identify the contactee to the contactor. When the communicant identifier identifies a contactee, the communicant alias is presented to identify the contactor in a role, relationship, task, and/or other communications context.

Communications agent 404a operating in contactee node 504 may present a representation of the communication subsequent to receiving data in the communication from contactor node 502. The communication may be represented by presentation controller component 420a in contactee node 504 for viewing by the contactee in a user interface. FIG. 6b illustrates communications agent window 602b presenting a view of received communications including communicant aliases for contactors. Communications agent window 602b includes a tree view pane 604b illustrating folders, categories, domains, tags, and/or other contextual information for organizing communications in a hierarchy. The communications may be text-based, such as email; voice-based, such as voice-mail; and/or image-based. In an aspect, a communication may be included in more than one path in the hierarchy. In another aspect, tree view pane 604b may provide a presentation space for presenting various types of hierarchies defined based on folders, tasks, communicants, communicant aliases, message status, message priority, groups, accounting codes, and/or any other suitable attribute(s) for categorizing and/or otherwise organizing communications.

Communications agent window 602b also illustrates a communications view pane 606b. In FIG. 6b, an “In” item 608b is illustrated as selected by a box surrounding “In”. Communications view pane 606b presents representations of communications included in the selected “In” item 608b. Communications view pane 606b illustrates representations of communications identifying a date and time a communication was received, a priority, and a communicant alias of the sender or contactor for the communication. The presented communicant alias is located based on a communicant identifier of the contactee as described above. Message UI element 614b my present a message in a selected communication, such as first communication 610b illustrated as selected by a surrounding box.

In an example, the communicant represented by contactor node 502 in the role of a contactor may send a communication to contactee node 504. The communicant identifier received may be a home or family communications address of the contactee and/or a communicant alias, such as “spouse”, identifying the contactee. Contactor node 502, contactee node 504, path node 508, and/or CID service node 510 may identify “spouse” as the communicant alias identifying the contactor based on the communicant identifier of the contactee. “Spouse” may be presented by contactor node 502 to the contactor illustrating the contactor's role or relationship to the contactee in the communication. FIG. 6b illustrates that the communicant alias “spouse” may be presented to the contactee by contactee node 504 to identify the contactor and a domain or context associated with the communication. Note that in this example, both the contactor and the contactee may be identified by a “spouse” communicant alias reflecting their peer relationship.

In another example, the contactee represented by contactee node 504 may be an engineer on a project led by the contactor represented by contactor node 502. The communicant identifier received may identify the contactee in the context of the project by an alias and/or communications address. The communicant alias, “lead engineer”, may match a matching condition based on the communicant identifier received for the contactee. Contactor node 502, contactee node 504, path node 508, and/or CID service node 510 may locate and/or otherwise identify “Lead Engineer” as a communicant alias for the contactor based on the communicant identifier for the contactee. Contactor node 502, contactee node 504, path node 508, and/or CID service node 510 may further send presentation information for presenting the communicant alias to the contactor in contactor node 502 and/or for presenting the communicant alias to the contactee by the contactee node 504 as illustrated in FIG. 6b.

FIG. 6b illustrates first communication 610b from the communicant represented by contactor node 502 and illustrates second communication 612b also from the communicant represented by contactor node 502. The communicant alias identifying the contactor is “spouse” for first communication 610b and is “lead engineer” for the second communication providing the contactee communicant and/or the communications agent representing the contactee with additional information for organizing, presenting, storing, managing, and/or otherwise processing the two communications.

While FIG. 6b illustrates a contactor communicant alias presented via an output device of a contactee node, those skilled in the art will see that contactee aliases may be presented by a contactee node. Contactor and/or contactee communicant aliases may be presented via an output device of a contactor node. For example, in FIG. 6b, the communications agent in contactee node 504 may receive an indication to present the communication in communications view pane 606b including communicant aliases for the contactee of the communication. A presented representation of first message 610b may/would present “spouse” as a communicant alias identifying the contactor and a presented representation of second message 612b may identify the contactee in the context of the engineering project. For example, the contactee may be a “test engineer”, a “writer”, a “product planner”, and the like. When presented by the communications agent in contact node 502 representations of first communication 610b and second communication 612b may present the same contactor and/or contactee communicant aliases and/or may present different communicant aliases based on configuration preferences for the contactor, based on the communications agent in contactor node 502, based on the configuration of CID 428 in contactor node 502 and in contactee node 504, and/or based on the configuration of CID service node 510.

In contactor node 502 and/or contactee node 504, presentation information may be sent by an instance of and/or analog of representation engine 456a operating in respective nodes. Alternatively or additionally, representation engine 456b may include presentation information for the located communicant alias in the communication and/or otherwise send the presentation information to contactee node 504 and/or contactor node 502 for presenting by an output device in an execution environment of the respective contactee node 504 and/or contactor node 502. In FIG. 4c, representation engine 456c may send presentation information in a response to a request for locating the communicant alias. The presentation information may be sent to any requesting node, including contactor node 502, contactee node 504, and/or path node 508 for presenting by an output device.

When the communicant identifier received is for the contactor, the communicant alias is presented to identify the contactee in a role, relationship, task, and/or other communications context. When the communicant identifier identifies a contactee, the communicant alias is presented to identify the contactor.

A communication may be represented for viewing, for editing, for sending a follow-up communication, for categorizing, and/or for otherwise manipulating and/or managing. A representation of a communication along with a communicant alias may be presented in a list view, a grid view, a tree view, and/or a folder few, to name a few exemplary contexts for presenting a representation of the communication. A representation of the communication may be presented in an alert message, a pop-up, a fly-over or roll-over UI element, as a desktop item, a task bar item, a favorites item, a history item, and/or in a to-do or task list.

The method illustrated in FIG. 2 may include additional aspects supported by various adaptations and/or analogs of the arrangement of components in FIG. 3. In various aspects, a communication may include an email, a fax, an audio communication, a video communication, a text communication, and/or an instant message.

As described above, a communicant identifier may include a communications address and/or a communicant alias for a communications address. The communications address and/or the communicant alias may be received in a communication. The communications address may be included in an address space of a communications protocol specified for exchanging data in the communication. The communications address space may include an email address space, an instant message address space, a voice communications protocol address space, a session initiation protocol address space, an application layer address space, a presentation layer address space, a session layer address space, a transport layer address space, a network layer address space, and/or a link layer address space.

Locating a communicant alias based on a received communicant identifier may include determining that a matching condition based on the communicant identifier is met. A matching condition may include a matching expression such as regular expression. The matching condition may include a conditional and/or logical expression such as may be expressed in an SQL query. One or more communicant aliases may be located based on the received communicant identifier.

Locating the communicant alias may include locating a stored association identifying the communicant identifier and identifying the communicant alias. The association may identify a named relationship between the contactor communicant and the contactee communicant. The located communicant alias may be included in a naming domain that defines at least one of a format and a vocabulary for determining that the communicant alias is included in the naming domain. For example, a record may be stored in CID 428 in FIG. 4a, FIG. 4b, and/or FIG. 4c. A communicant alias “Advertising” may associate an identifier of a communicant with one or more communicants that work for and/or provide advertising services. A schema for the naming domain identified by “Advertising” may be defined by names of companies registered with a government agency as operating in the advertising business as identified by a business code specified by the government agency. Thus, the names registered with the government agency define a vocabulary for the naming domain of the communicants in a relationship with the communicant alias “Advertising”. A lookup component 452 in FIG. 4a, FIG. 4b, and/or FIG. 4c may determine valid names in the domain based on registration information accessible from the government agency.

The communicant identifier may be associated with the communicant alias via a list. For example, the communicant identifier “Advertising” described in the previous paragraph identifies a list of communicant's aliases.

The association between the communicant identifier and the communicant alias may identify and/or may be defined by a relationship between the contactor communicant and the contactee communicant. The relationship identifies at least one of the contactor communicant and the contactee communicant in an identifiable domain and/or specified context. The examples described above for the aliases “Dad”, “Employee”, and “Boss” illustrate aliases that identify relationships between communicants.

Exemplary domains include a business naming domain, a demographic naming domain, a familial naming domain, a financial naming domain, a political naming domain, a social naming domain, a group naming domain, a religious naming domain, an athletic naming domain, an educational naming domain, a security naming domain, a time-based naming domain, a task-based naming domain, a transaction-based naming domain, a geospatial naming domain, a hierarchical naming domain, a peer naming domain, an acyclic naming domain, a cyclic naming domain, a process naming domain, a system naming domain, a transactional naming domain, a privacy naming domain, an operational naming domain, a travel naming domain, a topic-based naming domain, a service naming domain, a field of knowledge naming domain, and/or any useful and/or otherwise suitable naming domain for a communicant, administrator, and/or component included in processing the communication.

Further, the communicant identifier and the communicant alias may identify a family role, a business title, a peer group identity, a location in a hierarchy, a location in a cyclic graph, a location in an acyclic graph, a state of a transaction, a type of transaction, a particular transaction a location in a geospatial region, a direction of movement, a speed of movement, a type or means of movement, a role in a task, a particular task, a state of a task, a security attribute, a role in a process, a process input, a process output, a type of process, a process state, a component in a process, a function in a system, a system input, a system product and/or by-product, a type of system, a system state, a role in a service, a service input, a service output, a type of service, a service provider, a service user, a service state, a topic attribute, a level of knowledge, a level of contribution, and/or any attribute or metadata for the communications that may be a useful and/or otherwise suitable naming domain for a communicant, administrator, and/or component included in processing the communication.

The association between the communicant identifier and the communicant alias may be user configurable and/or may be automatically created and/or updated based on one or more previous communications between the contactor communicant and the contactee communicant. The previous communication may include a previous communications address in a previous address space of a previous communications protocol different from than the first communications protocol. For example, an association between a “Client” and an “Attorney” may be identified via a communicant alias communicated in a voice communication between contactor node 502 and contactor node 504. Through an association between a communicant's phone address and the communicant's email address maintained in CID 428a, the client-attorney relationship may be associated with email addresses of one or both communicants in the phone communication.

As described above, a communicant alias may be selected automatically in response to determining that the matching condition is met. Further, the communicant alias may be selected automatically in response to receiving the communicant identifier. In another aspect a communicant alias may not be selected automatically. The communicant alias may be presented to a user (i.e. communicant) of contactor node 502, for example. Alias selection component 454a may interoperate with presentation controller component 420a and/or one or more UI element handler components 418a to present the communicant alias selector via a display device in execution environment 402a. The communicant alias may be presented to allow the user to confirm that the correct and/or suitable communicant has been identified. In response to detecting an input from the user to select the presented representation, presentation controller component 420a may indicate to alias selection component 454a that the communicant alias has been selected. The communicant alias may be selected in response to detecting the user input.

The communicant alias may be presented along with one or more other communicant aliases that meet a matching condition based on the communicant identifier. The matching condition may be the same or different for the communicant aliases presented. A user input may be detected selecting one or more communicant aliases in addition to the communicant alias. All of the communicant aliases corresponding to the one or more selection inputs may be selected, in response to the one or more selection inputs.

The communicant alias may be associated with and/or otherwise identify multiple communications addresses in one or more address spaces of one or more corresponding communications protocols. A communications address from the multiple addresses may be included in a communications based on the communicant identifier, the first client, the second client, the path node, a first communications address for the first participant, a type of data for exchanging, and a user input.

When a received communicant identifier identifies the contactee, the communicant alias identifies the contactor. The presentation information may be sent to present the communicant alias to identify at least one of the contactor, a domain of the contactor, and a role of the contactor. When a received communicant identifier identifies the contactor, the communicant alias identifies the contactee. The presentation information may be sent to present the communicant alias to identify at least one of the contactee, a domain of the contactee, and a role of the contactee.

In an aspect, a communicant identifier may be received by a contactor communications agent in contactor node 502 for sending data in a communication to the contactee communicant represented by a contactee communications agent operating in contactee node 504. Communicant handler component 450a may receive a communicant identifier for creating a communication.

As described above, a communicant identifier may be received, via the network, from a contactor node. The communicant identifier may be received by at least one of a contactee node and a path node in a network path communicatively coupling the contactor node and the contactee node. Some or all of the method illustrated in FIG. 2 may be performed in whole or in part by any a contactor node, a contactee node, a path node, and a CID service node with respect to a communication.

The communication identifier may be received via the network in data for initiating a communication between a contactee node and contactor node.

In an aspect, the method illustrated in FIG. 2 may further include receiving a communications address of the communicant identified by the communicant alias. The communicant alias may be located based on the communicant identifier and based on the communications address.

Sending the presentation information may include sending the presentation information for presenting via an output device of a contactor node and/or may include sending presentation information for presenting via an output device of a contactee node.

The method illustrated in FIG. 2 may further include detecting a user input corresponding to a user detectable representation of a communication and initiating the communication, in response to detecting the user input, including sending data on behalf of the contactor communicant by the contactor node for delivery via the network to the contactee node.

The contactor node and the contactee node may be communicatively coupled via a path node in the network. The path node may receive the communicant identifier sent by the contactor node. The path node may send the presentation information in the communication to the contactee node for presenting by the output device.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more instruction-processing units, or by a combination of both. The description herein of any sequence of actions is not intended to imply that the specific order described for performing that sequence must be followed.

Moreover, the methods described herein may be embodied in executable instructions stored in a computer readable medium for use by or in connection with an instruction execution machine, system, apparatus, or device, such as a computer-based or processor-containing machine, system, apparatus, or device. As used here, a “computer readable medium” may include one or more of any suitable media for storing the executable instructions of a computer program in one or more of an electronic, magnetic, optical, electromagnetic, and infrared form, such that the instruction execution machine, system, apparatus, or device may read (or fetch) the instructions from the computer readable medium and execute the instructions for carrying out the described methods. A non-exhaustive list of conventional exemplary computer readable media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD.™.), a Blu-ray.™. disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method for identifying a communicant in a communication, the method comprising:
receiving a communicant identifier identifying one of a contactor communicant and a contactee communicant in a communication, via a network, between a contactor node representing the contactor communicant and a contactee node representing the contactee communicant;
locating, based on the communicant identifier, a communicant alias for identifying the contactor communicant when the communicant identifier identifies the contactee communicant and identifying the contactee communicant when the communicant identifier identifies the contactor communicant; and
sending presentation information for presenting the communicant alias in a representation of the communication presented via an output device.

2. The method of claim 1 wherein the communication includes at least one of an email, a fax, an audio communication, a video communication, a text communication, and an instant message.

3. The method of claim 1 wherein the communicant identifier includes at least one of a communications address and a communicant alias for the communications address, wherein the communications address is included in an address space of a communications protocol for exchanging data in the communication via the network.

4. The method of claim 1 wherein the communicant alias is located based on a named relationship between the contactor communicant and the contactee communicant.

5. The method of claim 1 wherein the communicant alias is included in a naming domain that defines at least one of a format and a vocabulary for determining that the communicant alias is a valid name in the naming domain.

6. The method of claim 5 wherein the naming domain includes at least one of a business naming domain, a demographic naming domain, a familial naming domain, a financial naming domain, a political naming domain, a social naming domain, a group naming domain, a religious naming domain, an athletic naming domain, an educational naming domain, a security naming domain, a time-based naming domain, task-based naming domain, a transaction-based naming domain, a geospatial naming domain, a hierarchical naming domain, a peer naming domain, an acyclic naming domain, a cyclic naming domain, a process naming domain, a system naming domain, a transactional naming domain, a privacy naming domain, an operational naming domain, a travel naming domain, topic based naming domain, a service naming domain, and a field of knowledge naming domain.

7. The method of claim 1 wherein at least one of the communicant identifier and the communicant alias identifies a role of at least one of the contactor communicant and the contactee communicant.

8. The method of claim 1 wherein the presentation information is sent automatically, in response to locating the communicant alias.

9. The method of claim 1 wherein sending the presentation information comprises:
presenting the located communicant alias to a user via an output device;
detecting a user input selecting the communicant alias; and
sending the presentation information, in response to detecting the user input.

10. The method of claim 1 wherein the communicant alias is associated with a plurality of communications addresses and the method further includes determining a communications address, for the one of the contactee communicant and the contactor communicant identified by the located communicant alias, based on at least one of the communicant identifier, the contactor node, the contactee node, a communications address for the other one of the contactee communicant and the contactor communicant, a content type of data in the communication, and a detected user input.

11. The method of claim 1 wherein the communicant identifier identifies the contactee and the communicant alias identifies the contactor and wherein sending the presentation information comprises sending the presentation information to present the communicant alias to identify at least one of the contactor, a domain of the contactor, and a role of the contactor.

12. The method of claim 1 wherein the communicant identifier identifies the contactor and the communicant alias identifies the contactee and wherein sending the representation information comprises sending the representation information to present the communicant alias to identify at least one of the contactee, a domain of the contactee, and a role of the contactee.

13. The method of claim 1 wherein the communicant identifier is received, in the communication, by a contactor communications agent in the contactor node for sending data in the communication to the contactee node.

14. The method of claim 1 wherein the communicant identifier is received, via the network, from the contactor node, by at least one of the contactee node and a path node in a network path communicatively coupling the contactor node and the contactee node.

15. The method of claim 14 wherein the method is performed by at least one of the path node and the contactee node.

16. The method of claim 1 wherein the communicant alias is located based on a communications address of the one of the contactor communicant and the contactee communicant identified by the communicant alias.

17. The method of claim 1 further comprises:
detecting a user input corresponding to the representation to initiate the communication; and
initiating the communication, in response to detecting the user input, including sending data on behalf of the contactor communicant by the contactor node for delivery via the network to the contactee node.

18. The method of claim 1 wherein the sending the presentation information includes sending the presentation information in the communication to the contactee node for presenting by the output device.

19. A system for identifying a communicant in a communication, the system comprising:
an execution environment including an instruction-processing unit configured to process an instruction included in at least one of a communicant handler component, a lookup component, and a representation component;
the communicant handler component configured for receiving a communicant identifier identifying one of a contactor communicant and a contactee communicant in a communication, via a network, between a contactor node representing the contactor communicant and a contactee node representing the contactee communicant;
the lookup component configured for locating, based on the communicant identifier, a communicant alias for identifying the contactor communicant when the communicant identifier identifies the contactee communicant and identifying the contactee communicant when the communicant identifier identifies the contactor communicant; and
the representation component configured for sending presentation information for presenting the communicant alias in a representation of the communication presented via an output device.

20. A computer-readable medium embodying a computer program, executable by a machine, for identifying a communicant in a communication, the computer program comprising executable instructions for:
receiving a communicant identifier identifying one of a contactor communicant and a contactee communicant in a communication, via a network, between a contactor node representing the contactor communicant and a contactee node representing the contactee communicant;
locating, based on the communicant identifier, a communicant alias for identifying the contactor communicant when the communicant identifier identifies the contactee communicant and identifying the contactee communicant when the communicant identifier identifies the contactor communicant; and
sending presentation information for presenting the communicant alias in a representation of the communication presented via an output device.
